(19) United States
(12) Patent Application Publication
(10) Pub. No.: US 2018/0321157 A1
(43) Pub. Date: Nov. 8, 2018

(54) ANALYTE INDUCED CHEMILUMINESCENT SPRAY SYSTEM AND METHODS RELATED THERETO

(71) Applicant: Jason B. Terrell, Burnet, TX (US)

(72) Inventor: Jason B. Terrell, Burnet, TX (US)

(21) Appl. No.: 15/971,887

(22) Filed: May 4, 2018

Related U.S. Application Data
(60) Provisional application No. 62/501,609, filed on May 4, 2017.

(51) Int. Cl. G01N 21/76; G01N 1/31; B65D 83/20; B65D 83/68; B65D 83/14

(52) U.S. Cl. CPC G01N 21/766; G01N 1/31; C09K 11/07; B65D 83/68; B65D 83/752; B65D 83/202

(57) ABSTRACT

The present invention relates to a system and method for a liquid containing compound/s producing a visible chemiluminescent glow upon being distributed in the atmosphere in the presents of a targeted analyte. It is an object of the present invention to provide a system and method for discharging a chemiluminescent spray into the atmosphere, upon which, in the event of the presence of an analyte, such as H2S, a chemiluminescent reaction occurs.

### CROSS-REFERENCE TO RELATED APPLICATIONS

This application claims priority to provisional U.S. application Ser. No. 62/501,609, filed on May 4, 2017, entitled “Analyte Induced Chemiluminescent Spray System And Methods Related Thereto,” which provisional patent application hereby incorporated herein by reference in its entirety for all purposes.

### STATEMENT REGARDING FEDERALLY SPONSORED RESEARCH OR DEVELOPMENT

None.

### FIELD OF THE INVENTION

The present invention relates generally to spray chemiluminescence for entertainment and signaling purposes. The present invention includes chemical compound/s dispensed via spray or aerosol solution to produce a visible chemiluminescent glow in the presence of an analyte.

### BACKGROUND OF THE INVENTION

Multiple applications exist for a product providing aerosol delivery of chemiluminescent compounds. The entertainment industry constitutes the largest potential market. Entertainment applications include, but are not limited to, novelty gifts, private use by individuals and families, use at social events and parties (ranging from children's parties to night clubs and raves), and use at public venues (ranging from athletic events to concerts). These include, but are not limited to, military, law enforcement, and search and rescue.

### BRIEF SUMMARY OF THE DISCLOSURE

The present invention more particularly includes compound/s producing a visible chemiluminescent glow upon being distributed in the atmosphere. It is an object of the present invention to provide a system for discharging a chemiluminescent spray into the atmosphere, comprising a spray bottle having a first reservoir and a second reservoir, a first solution located within the first reservoir, and a second solution located within the second reservoir wherein the first solution and the second solution are expelled simultaneously via actuation of the spray bottle to form a chemiluminescent reaction in the atmosphere.

It is another object of the present invention to provide a method for discharging a chemiluminescent spray, comprising actuating a spray bottle comprising a first solution and a second solution, wherein the first solution and the second solution are expelled simultaneously via actuation of the spray bottle to form a chemiluminescent reaction

It is a further object of the present invention that the chemiluminescent reaction is a peroxyoxalate reaction. In one aspect the spray bottle may be a pressurized aerosol sprayer, an atomizer, and a trigger sprayer. In considering the chemical components of the solutions, the first solution may comprises Rose Bengal or may comprise 5,5-difluoro-1,3,7,9,10-pentamethyl-5H-4λ4,5λ4-dipyrrolo [1,2-c:2′,1′-f] [1,3,2] diazaborinine (BODIPY). The first solution may further comprise a solvent such as ethyl acetate, acetone, or combinations thereof The chemiluminescent reaction of the present invention may be green or red, although other colors and combinations of colors are possible. It is another object of the present invention that the expelled first solution and second solution are less toxic than other polyaromatic dye solutions. The present invention may have multiple uses, including for entertainment and novelty purposes. The present invention may further comprise chemiluminescence only in the presents of certain analytes, such as gases which are present in certain discharges, such as colonic flatulence.

It is a further object of the present invention to provide a system for discharging a chemiluminescent spray into the atmosphere, comprising a spray bottle having a first reservoir and a second reservoir, a first solution located within the first reservoir, and a second solution located within the second reservoir, wherein the first solution and the second solution are expelled simultaneously via actuation of the spray bottle to form a chemiluminescent reaction in the atmosphere. The chemiluminescent reaction is a peroxyoxalate reaction. The spray bottle may be selected from the group consisting of: a pressurized aerosol sprayer, an atomizer, and a trigger sprayer. In one aspect, the first solution comprises bis (2,4,6-trichlorophenyl) oxalate, difluoro{2-[1-(3,5-dimethyl-2H-pyrrol-2-ylidene-N)ethyl]-3,5-dimethyl-1H-pyrrolato-N}boron, and imidazole. In another aspect the first solution comprises 5,5-difluoro-1,3,7,9,10-pentamethyl-5H-4λ4,5λ4-dipyrrolo [1,2-c:2′,1′-f] [1,3,2] diazaborinine (BODIPY). The first solution may comprise a solvent selected from a group consisting of: ethyl acetate, acetone, or a combination thereof. The second solution may thereafter comprise an aqueous solution comprising hydrogen peroxide, which may further range from about 2% to 20% hydrogen peroxide. In another aspect, the second solution comprises about 3% hydrogen peroxide. In one aspect of the present invention, the resulting chemiluminescent reaction is green. In another aspect, chemiluminescent reaction is red, and the first solution may further comprises Rose Bengal.

It is a further object of the present invention to provide a method for discharging a chemiluminescent spray, comprising actuating a spray bottle comprising a first solution and a second solution, wherein the first solution and the second solution are expelled simultaneously via actuation of the spray bottle to form a chemiluminescent reaction. In one aspect the chemiluminescent reaction is a peroxyoxalate reaction. The spray bottle may be a pressurized aerosol sprayer, an atomizer, or a trigger sprayer. The first solution may comprise bis (2,4,6-trichlorophenyl) oxalate, difluoro{2-[1-(3,5-dimethyl-2H-pyrrol-2-ylidene-N)ethyl]-3,5-dimethyl-1H-pyrrolato-N}boron, and imidazole, in a solution comprising a solvent. The solvent may ethyl acetate, acetone, or a combination thereof. In another aspect the first solution comprises 5,5-difluoro-1,3,7,9,10-pentamethyl-5H-4λ4,5λ4-dipyrrolo [1,2-c:2′,1′-f] [1,3,2] diazaborinine (BODIPY).

The present invention may further comprise chemiluminescence only in the presents of certain analytes, such as gases which are present in certain discharges, such as colonic flatulence.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIGS. 1A-1B depict images of chemiluminescent acceptor dyes.

FIGS. 2A-2D depict images of multiple color-based chemiluminescent aerosol sprays.

FIG. 3 depicts a chart showing chemiluminsecence emission in a multi-well plate format of a solution of 4.07 mM BODIPY, 2.44 mM TCPO, 4.19 mM Imidazole and 2-14 mM H2O2 (final concentrations) in ethyl acetate solvent.

FIG. 4 depicts an exemplary atomizer for use with the present invention.

FIGS. 5A-5B depict an exemplary pressurized aerosol configuration.

FIG. 6 depicts an exemplary hand pump.

FIG. 7 depicts an exemplary spray bottle having a trigger spray configuration.

FIG. 8 depicts an exemplary single spray, double reservoir configuration for single spray use.

FIGS. 9A-C depicts applicable formulas of compounds capable of use with the present invention.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

While the making and using of various embodiments of the present disclosure are discussed in detail below, it should be appreciated that the present disclosure provides many applicable inventive concepts that can be embodied in a wide variety of specific contexts. The specific embodiments discussed herein are merely illustrative of specific ways to make and use the disclosure and do not limit the scope of the disclosure.

All publications and patent applications mentioned in the specification are indicative of the level of skill of those skilled in the art to which this disclosure pertains. All publications and patent applications are herein incorporated by reference to the same extent as if each individual publication or patent application was specifically and individually indicated to be incorporated by reference.

The present disclosure will now be described more fully hereinafter in a reasonably broad scope for claimed or covered subject matter that is intended. Among other things, for example, subject matter may be embodied as methods, devices, components, or systems. The following detailed description is, therefore, not intended to be taken in a limiting sense.

The present invention can be developed and/or modified from original form to comply with the chemical constraints and economic requirements of manufacturing, storage, distribution and retail price point. A detailed description of the present invention is contained within this section.

The present invention includes compound/s producing chemiluminescence upon aerosolization. The compound/s of present invention can be used independently or in combination with reagents to facilitate the reaction. Health/safety and environmental impact studies are required prior to selection of the most appropriate chemical reaction. Additional considerations influencing selection of the chemical combination include manufacturing costs, shelf-life limitations and storage condition requirements. The end product utilizing the compound/s of the present invention will conform to safety standards and economical manufacturing/distribution at a marketable retail price point.

The end product centers on utilization of the compound/s of the present invention. The compound/s constituting the present invention and the delivery system employed are interdependent and therefore described below as systems.

In one embodiment, the system of the present invention utilizes independent chemiluminescent compound/s producing visible chemiluminescence upon aerosol deployment. The aerosol spray consists of two different solutions being sprayed simultaneously to generate bright chemiluminescence at the intersection of the solutions.

In another embodiment, the system of the present invention utilizes compounds producing chemiluminescence upon a conformational change triggered by the pressure change created when the aerosol spray valve is depressed.

In another embodiment, the system of the present invention utilizes reagent compounds yielding a chemiluminescence reaction activated by a mixing process as the aerosol container is shaken prior to use.

In another embodiment, the system of the present invention utilizes reagent compounds isolated prior to deployment. Isolation is maintained by incorporation of separate/sealed compartments within the container. Mixing of the compartments and reagent compounds is accomplished by incorporation of an activation system into the container.

The chemiluminescent compound/s may be dispensed via multiple delivery mechanisms and packaging systems. The present invention encompasses all known and novel delivery methods and packaging systems allowing the compound/s to be dispersed. These include, but are not limited to, all forms, configurations and usage of pressurizers, pumps, compressors, misters, atomizers, nebulizers, vaporizers, liquid propellants, gas propellants, combination liquid-gas propellants, chemical pressurization systems, manual pressurization systems, electronic systems and modifications thereof, aerosolization systems and modifications thereof, 2K (two component) aerosol systems and modifications thereof, piston barrier systems and modifications thereof, bag-on valve systems and modifications thereof. Any other system of delivery, packaging and/or dispersement of chemiluminescent compound/s is included within the scope of the present invention.

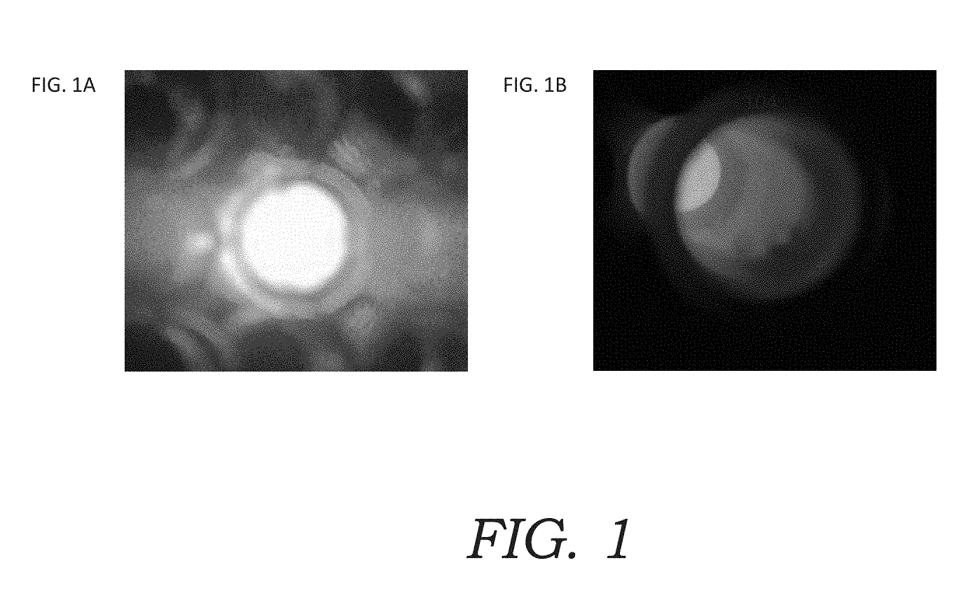

Turning to the figures of the present invention, various aspects and embodiments are described. FIGS. 1A-1B present exemplary images of chemiluminescent acceptor dyes. In one embodiment, Use of Rose Bengal in a peroxyoxalate chemiluminescent uses ˜13 mM H2O2, 3.7 mM imidazole, and 3.1 mM TCPO, as shown in FIG. 1A. In another embodiment, a peroxyoxalate chemiluminescent reaction uses 5,5-difluoro-1,3,7,9,10-pentamethyl-5H-4λ4,5λ4-dipyrrolo [1,2-c:2′,1′-f][1,3,2]diazaborinine (BODIPY) as shown in FIG. 1B. In another embodiment, the reaction utilizes Rose Bengal in 9:1 EtOAc:CH3CN. The use of Rose Bengal within the embodied compositions allows for the reaction to have a visible red color.

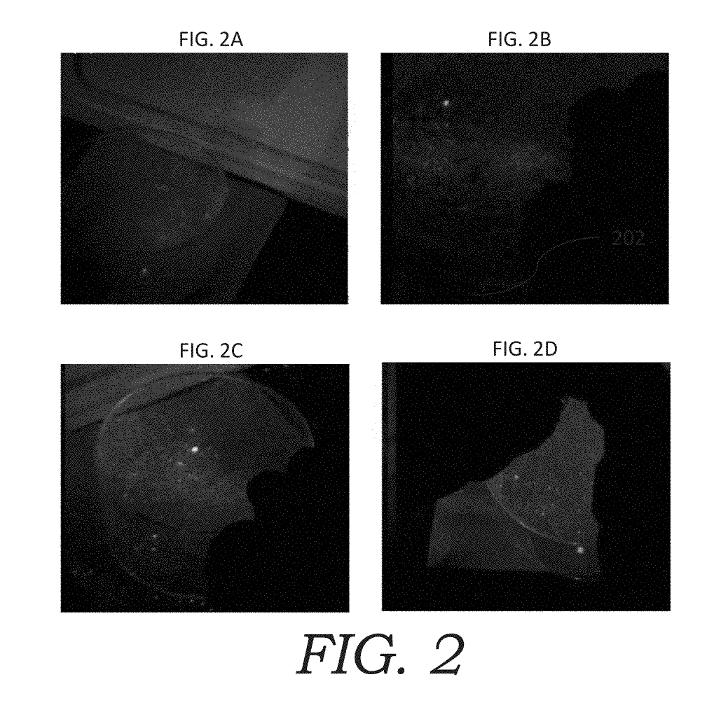

FIGS. 2A-2D provide multiple exemplary configurations of colored chemiluminescent aerosol sprays. FIG. 2A shows a blue spray consisting of 150 mM α-cyclodextrin, 6 mM luminol, 3 mM Co (II), and 55 mM NaOH in H2O sprayed from one atomizer and 35% H2O2 sprayed from a second atomizer. A perfume atomizer is loaded with a 150 mM α-cyclodextrin, 6 mM luminol, 3 mM Co (II), and 55 mM NaOH (in H2O). A second perfume atomizer is loaded with ˜1 mL 35% H2O2. The atomizers are sprayed so that the expelled solutions intersect providing a bright and visible chemiluminescent mist.

FIG. 2B shows a red spray consisting of 500 μL of 7 mM Rose Bengal, 300 μL of 7 mM TCPO, and 60 μL of 60 mM imidazole in 9:1 ethyl acetate:acetone sprayed from one atomizer and 35% H2O2 sprayed from a second atomizer. Use of Rose Bengal in the chemiluminescent formula to provide a red spray with less toxicity than other polyaromatic dyes. FIG. 2C shows a yellow spray consisting of 500 μL of 7 mM rubrene, 300 μL of 7 mM TCPO, and 60 μL of 60 mM imidazole in 9:1 ethyl acetate:acetone sprayed from one atomizer and 35% H2O2 sprayed from a second atomizer. FIG. 2D shows a green spray consisting of 500 μL of 7 mM 5,5-difluoro-1,3,7,9,10-pentamethyl-5H-4λ4,5λ4-dipyrrolo[1,2-c:2′,1′-f][1,3,2]diazaborinine (BODIPY), 300 μL of 7 mM TCPO, and 60 μL of 60 mM imidazole in 9:1 ethyl acetate:acetone sprayed from one atomizer and 35% H2O2 sprayed from a second atomizer. In another embodiment, the use of ethyl acetate and acetone as the solvent to provide an aerosol with less toxicity. In an exemplary embodiment, a perfume atomizer is loaded with a 500 μL solution of 7 mM rubrene, diphenyl anthracene, Rose Bengal, or BODIPY, 300 μL of 7 mM TCPO, 60 μL of 60 mM imidazole (all solutions in 9:1 ethyl acetate:acetone). A second perfume atomizer is loaded with ˜1 mL 35% H2O2. The atomizers are sprayed so that the expelled solutions intersect providing and bright a visible chemiluminescent mist. The two solutions may be combined into a single dispensing apparatus for simultaneous spraying as set forth above.

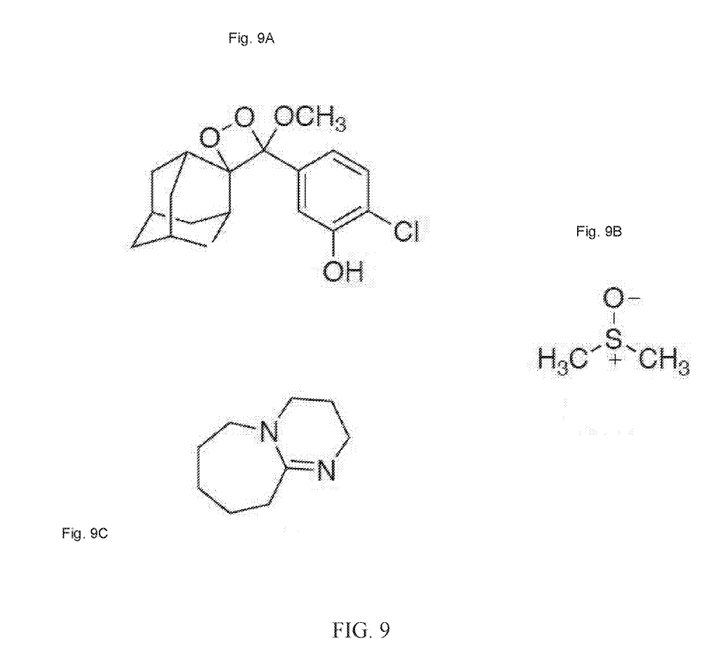

In other embodiments, compositions set for the in FIGS. 9A-C: spiroadamantane FIG. 9A, 1,8-diazabicylo(5.4.0)undec-7-ene (DBU) FIG. 9C, and dimethylsulfoxide (DMSO) FIG. 9B, are utilized to show naked-eye observable chemiluminescence.

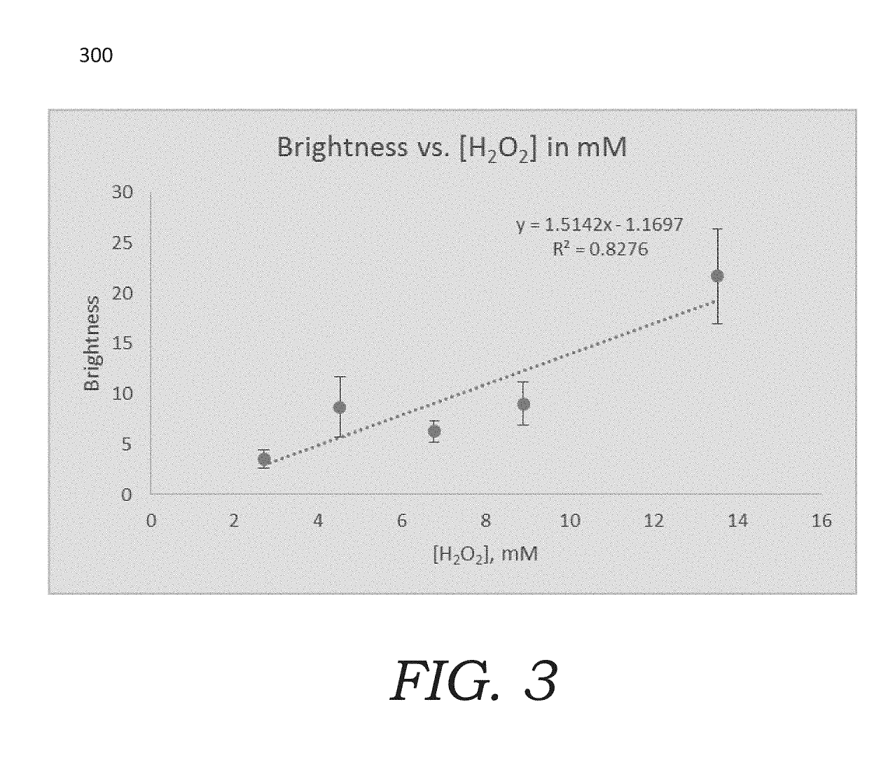

In another embodiment, chemiluminescent reagent TCPO showed superior stability in pure ethyl acetate versus acetone and solvent mixtures containing acetone. Nuclear magnetic resonance (NMR) studies were performed to address the stability of bis-(2,4,6-trichlorophenyl) oxalate (TCPO). TCPO was dissolved in pure ethyl acetate, pure acetone, or a mixture of ethyl acetate and acetone over an extended time period. Observing the NMR signals of the aromatic protons on TCPO allowed monitoring of the decomposition. While solutions in acetone and solvent mixtures showed significant decomposition of the reagent, solutions in pure ethyl acetate were stable for periods up to a week. Solutions in pure ethyl acetate are preferred for longer shelf life. Therefore in an exemplary embodiment, ethyl acetate may be used as the only organic solvent. Upon observing the stability of TCPO in ethyl acetate, chemiluminescent experiments were performed in a well-plate format to assess luminescence response. FIG. 3 presents a demonstration of chemiluminescence emission in a multi-well plate format of a solution of 4.07 mM BODIPY, 2.44 mM TCPO, 4.19 mM Imidazole and 2-14 mM H2O2 (final concentrations) in ethyl acetate. It was found that reactions performed in pure ethyl acetate showed comparable brightness to experiments performed in ethyl acetate:acetone mixture.

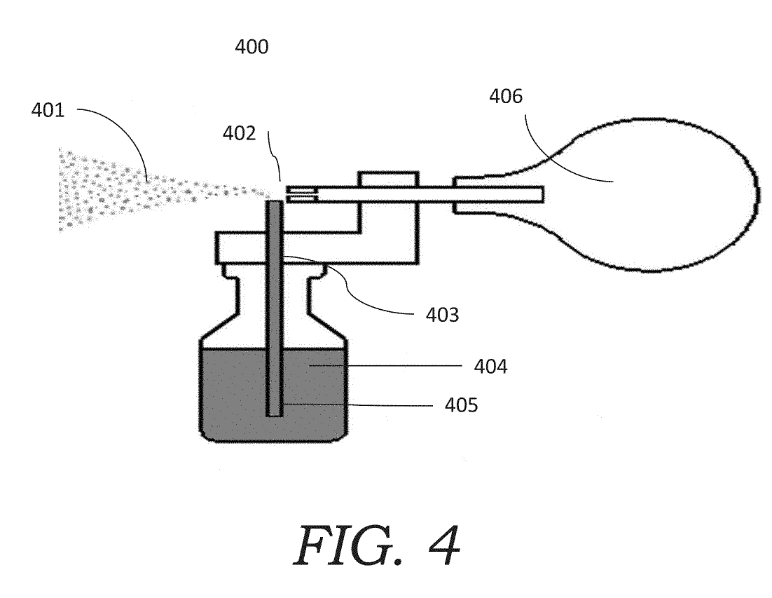

In another embodiment an atomizer is utilized as a non-pressurized system for distribution of solution into the air. Turning to FIG. 4, an atomizer 400 comprises a vessel 404, a dip tube 403 which extends below a liquid 405, a bulb or pressure actuator 406, and a nozzle 402. The spray 401 comprising atomized solution is presented from the dip tube 403 into the atmosphere following actuation of the pressure actuator 406. Previous experimentation with non-pressurized aerosol forming systems revealed that SECRET NO. 28 of 37 Hollywood Perfume Atomizer (Hollywood Fashion Secrets, Minneapolis, Minn.) to be optimal among the non-pressured systems tested. An organic solvent system containing TCPO, dye, and imidazole was loaded in a first atomizer and an aqueous peroxide solution was loaded in a second atomizer. In this phase, the effect of using BODIPY as a dye and lowering the concentration of hydrogen peroxide was investigated. BODIPY was used as a dye and peroxide concentrations of 35%, 23%, 17.5%, and 12.5% were used. In general, each of these peroxide concentrations provided qualitatively similar performance. An experiment using 3% peroxide was also performed, but yielded poor results.

In one embodiment, a first solution of peroxyolalate using BODIPY in 9:1 ethyl acetate is used, wherein a first atomizer comprises 500 μL 7 mM BODIPY, 300 μL 60 mM TCPO, and 60 μL 7 mM Imidazole, and a second atomizer comprises a 35% H2O2 solution. In another embodiment, the second atomizer comprises 23% H2O2 solution. In another embodiment, the second atomizer comprises 17.5% H2O2 solution. In yet another embodiment, the second atomizer comprises 12.5% H2O2.

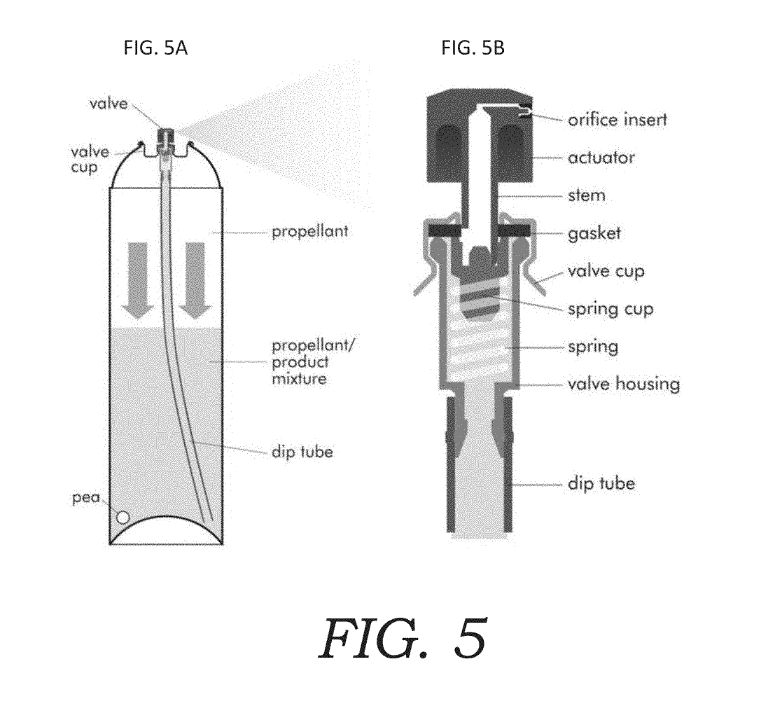

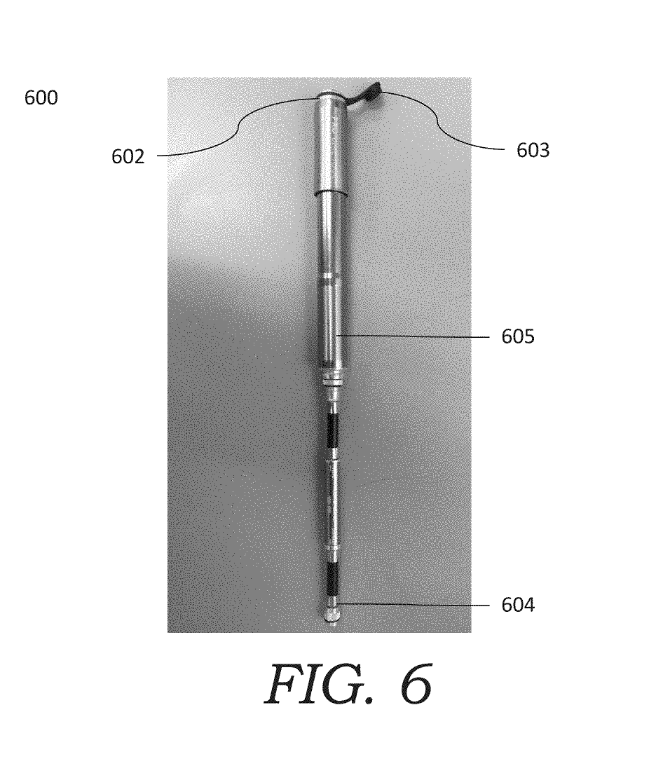

In another embodiment, a pressurized aerosol spray in combination with the Secret No 28 Hollywood Perfume Atomizer used in the examples above. An exemplary pressurized aerosol spray is identified in FIG. 5A and FIG. 5B, and comprise a propellant housed in a reservoir wherein a propellant/product mixture is mixed with the assistance of a ball or pea. Turning to FIG. 5A, a dip tube extends from the valve basally to the lower portion of the reservoir through the mixture. The propellant pushes the mixture through the dip tube to the valve housed within the valve cup. The exemplary valve in FIG. 5B comprises a orifice insert, an actuator pushed by a user, a stem, a gasket, a spring cup housing a spring, and valve housing in fluid communication with the mixture via the dip tube. The valve assembly is located within the valve cup. For an exemplary embodiment, the 16 oz TRUE POWER “Rechargeable Spot Sprayer” was identified as being suitable for these purposes due to compatibility with organic solvents and the ability to be easily pressurized using a hand pump (See FIG. 6). The pressurized aerosol has a maximum working pressure of 90 psi, and in one embodiment the pressure is generally kept between 40-60 psi. The bottle was equipped with a “misting” nozzle. Peroxyoxalate using BODIPY in Ethyl Acetate (4.07 mM BODIPY, 2.44 mM TCPO, 4.19 mM imidazole). 35% H2O2, 35% peroxide, and 3% peroxide were loaded into the atomizer and tested. While using a 35% peroxide solution resulted in good performance, the 3% peroxide solution yielded poorer results.

The use of the term BODIPY primarily references: 5,5-difluoro-1,3,7,9,10-pentamethyl-5H-4λ4,5λ4-dipynolo[1,2-c:2′,1′-f][1,3,2] diazaborinine. Some common derivatives add ethyl groups at the 2 and 8 position an aryl groups at the 10 position, and adding longer conjugated groups at the 3 and 7 position can change the color of emission of the present invention.

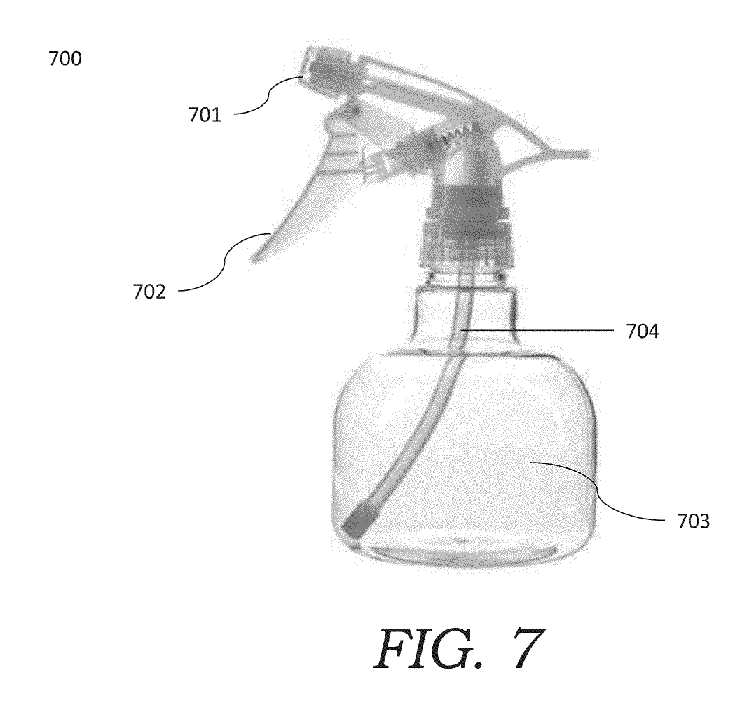

In another exemplary embodiment, a pressurized aerosol spray (see FIG. 7) such as a ZEP “Professional Sprayer” bottle. This spray bottle provided a larger volume and droplet size for delivery of hydrogen peroxide. A solution was used comprising Peroxyoxalate using BODIPY in Ethyl Acetate (Pressurized Aerosol: 4.07 mM BODIPY, 2.44 mM TCPO, and 4.19 mM Imidazole). It was found to give the best results of any aerosol system and provided a visible luminescence spray using 3% peroxide solution that is readily available from general pharmacies. Increasing the concentration to 17.5% peroxide provided a very bright chemiluminescent spray. FIG. 7 provides an exemplary spray bottle 700 comprising a nozzle 701, which is capable of multiple droplet settings, a dip tube 704, a bottle containing a reservoir for solution 703, and a trigger 702 for hand-actuating a sprayer mechanism.

In a preferred embodiment, a pressurized aerosol spray is used in combination with a spray bottle. Using a solution of 17.5% hydrogen peroxide provides spectacular results and a bright, visible green spray. Using 3% hydrogen peroxide provides more modest results, but still has a visible green spray using more benign 3% hydrogen peroxide solutions. Therefore systematic optimization of the aerosol system using the BODIPY dye has generated a design where the chemiluminescence is visible as a glowing mist in a darkened room. The system that delivers 17.5% hydrogen peroxide from the spray bottle and the TCPO/BODIPY solution from the aerosol performed the best with a fantastically bright mist. A similar system that uses 3% hydrogen peroxide (purchased over-the-shelf at a local pharmacy), also performed well with a visible green chemiluminescent mist, albeit with a reduction in the overall brightness. Polyaromatic organic compounds commonly used in glow sticks are generally believed to be carcinogenic. BODIPY offers an advantage in this regard. Further, using a single organic solvent, ethyl acetate, should be better for safety regulations.

It is therefore an embodiment of the present invention to provide a pressurized aerosol spray (TCPO, BODIPY, Imidazole, and ethyl acetate) and a non-pressurized spray (3% hydrogen peroxide in water) into a single spray mechanism. The plastic non-pressurized spray apparatus comprises utilizing a reservoir for a peroxide solution to connect to the metal reservoir of the pressurized aerosol spray; connecting the spray mechanism to the nozzle of the pressurized spray using chemical adhesive, USP Class VI adhesive, epoxy or silicone adhesive or other method and fixing the spray mechanism to the reservoir via a dip tube. As such, a single pull of the spray bottle to release the peroxide solution will also release the pressurized aerosol spray containing the TCPO, BODIPY, Imidazole, and ethyl acetate. Other potential directions for the “Glow Spray” product include multiple colors and other types of spray formats.

In another embodiment, a perfume atomizer is loaded with a 150 mM α-cyclodextrin, 6 mM luminol, 3 mM Co (II), and 55 mM NaOH (in H2O). A second perfume atomizer is loaded with ˜1 mL 35% H2O2. The atomizers are sprayed so that the expelled solutions intersect providing a bright and visible chemiluminescent mist.

In another embodiment, A perfume atomizer is loaded with a 500 μL solution of 7 mM rubrene, diphenyl anthracene, Rose Bengal, or BODIPY, 300 μL of 7 mM TCPO, 60 μL of 60 mM imidazole (all solutions in 9:1 ethyl acetate:acetone). A second perfume atomizer is loaded with ˜1 mL 12.5% to 35% H2O2. The atomizers are sprayed so that the expelled solutions intersect providing and bright and visible chemiluminescent mist.

In another embodiment, a solution of Bis(2,4,6-trichlorophenyl) oxalate (2.44 mM), Difluoro{2-[1-(3,5-dimethyl-2H-pyrrol-2-ylidene-N)ethyl]-3,5-dimethyl-1H-pyrrolato-N}boron (4.07 mM), and imidazole (4.19 mM) was prepared in ethyl acetate solution. After stirring, the solution was transferred to a 16 oz. TRUE POWER “Rechargeable Spot Sprayer”. This sprayer was compressed to 60 psi through the use of a hand-pump, and the standard nozzle was replaced with the “misting” nozzle. Solutions of hydrogen peroxide in water, from 3% to 35% were transferred to a perfume atomizer. By spraying the BODIPY aerosol and H2O2 solutions in close proximity, a fine, green, chemiluminescent mist was formed.

In another embodiment, a solution of Bis(2,4,6-trichlorophenyl) oxalate (2.44 mM), Difluoro{2-[1-(3,5-dimethyl-2H-pyrrol-2-ylidene-N)ethyl]-3,5-dimethyl-1H-pyrrolato-N}boron (4.07 mM), and imidazole (4.19 mM) was prepared in ethyl acetate solution. After stirring, the solution was transferred to a 16 oz True Power “Rechargeable Spot Sprayer”. This sprayer was compressed to 60 psi through the use of a hand-pump, and the standard nozzle was replaced with the “misting” nozzle. The first test was of the reaction between the BODIPY solution and the 17.5% H2O2 solution. The 17.5% solution was transferred to a 946 mL Zep “Professional Sprayer” bottle. The spray bottle's nozzle was adjusted to create a mist of H2O2 solution. By spraying the BODIPY aerosol and H2O2 solutions in close proximity, a fine, green, chemiluminescent mist was formed. In another embodiment, the aforementioned process was repeated with the 3% H2O2 solution.

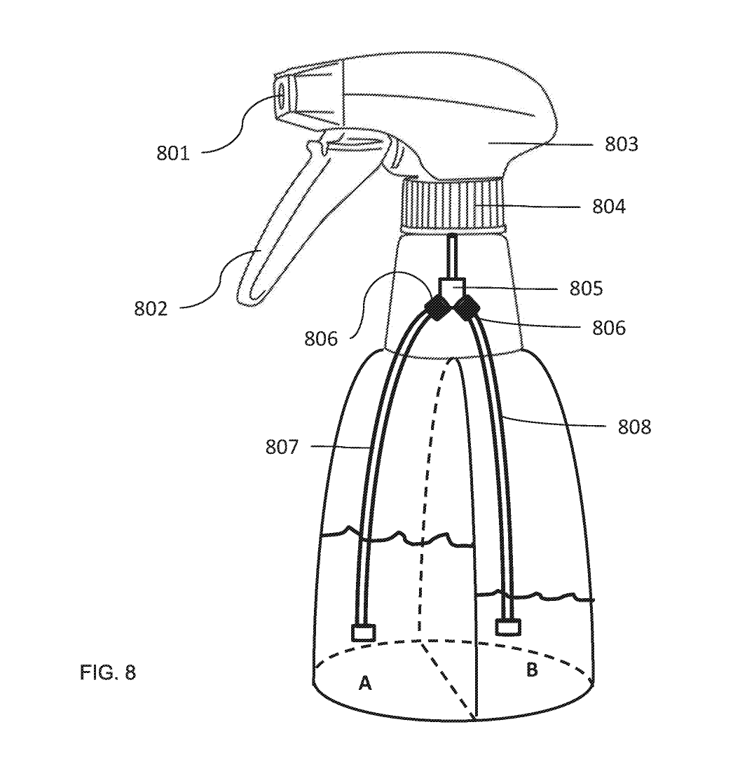

In another embodiment, a single spray system having two separated reservoirs, or vessels, wherein a tubing diverges into each of vessel “A” and vessel “B”, using a Y-type connector, check valves, and tubing (all low-density polyethylene) enables a chemiluminescent spray with a single handle dispenser (see FIG. 8). Turning to FIG. 8, a dual chamber sprayer is utilized having a misting nozzle 801, trigger 802 and trigger mechanism housed within a spray head 803 removably attached via threaded coupling 804. The mechanism within the spray head 803 actuates a pressurized mist to be deployed, drawing from each of vessel A and vessel B. A solution of bis (2,4,6-trichlorophenyl) oxalate (2.44 mM), difluoro{2-[1-(3,5-dimethyl-2H-pyrrol-2-ylidene-N)ethyl]-3,5-dimethyl-1H-pyrrolato- N}boron (4.07 mM), and imidazole (4.19 mM) was prepared in ethyl acetate solution and added to vessel “A”. An aqueous solution containing 3% hydrogen peroxide was added to vessel “B”. The two lengths of tubing 807, 808, in each respective vessel A and B, are connected with the Y-type connector 805 and inserted into vessel “A” and “B” respectively. Each of the tubing 807, 808 may further comprise a check valve 806 or other valve to prevent mixed compositions above the Y-type connector from back filling into vessel A or vessel B. A single pull of trigger 802 draws the respective compositions from both vessels to generate an easily visible glowing spray that is projected into the atmosphere. The resulting spray combining the two fluids provides an effectively bright chemiluminescent effect.

For either vessel A or vessel B, other additives, and polymers may be added as is known in the art, including but not limited to: cyclodextrin such as α-cyclodextrin, β-cyclodextrin, γ-cyclodextrin, and derivatives thereof, such as methylated or alkylated cyclodextrins. Examples are methylated β-cyclodextrin, hydroxypropyl- and hydroxyethyl-cyclodextrin (di)glucosyl- or (di)maltosyl-cyclodextrins carboxymethyl- or sulfoalkylether cyclodextrins, such as sulfobutylether-βcyclodextrin, or preservatives, such as benzalkonium, benzalkonium chloride, potassium sorbate, benzyl alcohol, thimerosal (merthiolate), edetate disodium monobasic sodium phosphate, providone, di-basic sodium phosphate, disodium ETA, potassium phosphate monobasic, iodine, phenylcarbinol, sodium silicoaluminate, and the like. Other carriers may be used such as soaps, buffers, and/or volatile oils or fragrances.

In another embodiment, a chemiluminescent composition is delivered capable of activation upon desired analytes associated with colonic flatulence. Fascination with flatulence is undeniable. Humorous references to the passing of gas date back to the 5th Century BC.[1][2] Simply stated, people naturally enjoy humor and many people find flatulence funny.

A large market exists for novelty products capitalizing on the public's fascination with flatulence and love of humorous practical jokes. For example, the Whoopee cushion was invented in the 1930's and has been purchased, at one point or another, by most American families.[3] The iFart smart phone app remains one of the most downloaded apps in history and recorded over $30,000 in sales in a single day.[4] While the Whoopee cushion and iFart app are low-cost products, a market also exists for higher priced novelty items. The Shake Weight by FitnessIQ, priced at over $20, sold over 2 million units resulting in over $40 million in sales in the first year of its release. According to media reports, the vast majority of Shake Weights were not purchased as exercise equipment but as novelty gag-gifts due to the provocative sexually suggestive motion of the device.[5]

Colonic flatus contains five odorless gases: nitrogen, hydrogen, carbon dioxide, oxygen, and methane. [6] Multiple factors contribute to composition and concentration. Nitrogen, hydrogen, and carbon dioxide are typically the major components. [7] Additional odorous components in highly variable concentrations include: sulfur-containing compounds, amines, short chain fatty acids, ammonia, indoles, skatoles and multiple miscellaneous trace compounds.[8][9][10]

A chemical product capable of producing a chemiluminescent reaction should be designed to react with the consistently predominant components of flatus. Selection of the target flatus gas combination is dependent upon chemical properties conducive to the desired reaction. A major consideration is flatus gas concentration relative to atmospheric air composition. The target must be significantly more concentrated in flatus versus atmospheric air in order to achieve the desired effect. Nitrogen and oxygen are therefore unsuitable targets. Of the consistently predominant odorless flatus gases, hydrogen, carbon dioxide, and methane are suitable targets within the appropriate gas concentration reaction ranges. Additionally, utilization of odorous components that are virtually nonexistent in atmospheric air are also viable targets.

The present invention more particularly includes novel chemical compound/s reacting with the components of colonic flatus to yield a visible chemiluminescent reaction. The chemiluminescent reaction occurs when the aerosolized novel compound/s combine with flatus gas components in ambient air:

REAGENT A+REAGENT B=CHEMILUMINESCENCE

REAGENT A represents the novel compound/s of invention. REAGENT B represents components of colonic flatus gas, or analyte.

A retail product with maximal efficacy will utilize chemiluminescent reactions with multiple flatus gases. The product of invention is capable of producing chemiluminescence with a combination of flatus gases. However, development, manufacturing and retail price point of such a compound may be cost prohibitive. In that event the most appropriate flatus gas will be selected as the final target. The present invention can be designed to react with a single or combination of flatus gas target/s in order to achieve economic manufacturing and a marketable retail price. The marketed form of the present invention will exhibit the most highly efficacious and cost effective chemiluminescent reaction possible utilizing the consistently predominant components of flatus.

In closing, it should be noted that the discussion of any reference is not an admission that it is prior art to the present invention, especially any reference that may have a publication date after the priority date of this application. Although the systems and processes described herein have been described in detail, it should be understood that various changes, substitutions, and alterations can be made without departing from the spirit and scope of the invention as defined herein. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### REFERENCES

1. “The Knights” by Aristophanes. http://classics.mit.edu//Aristophanes/knights.html on Apr. 10, 2015.
2. “The Clouds” by Aristophanes. http://classics.mit.edu//Aristophanes/knights.html on Apr. 10, 2015
3. “Whoopee Cushion Got First Airing Here”. Toronto Star. Mar. 31, 2008. http://www.thestar.com/life/2008/03/31/whoopee_cushion_got_first_airing_here.html on Apr. 12, 2015.
4. “iPhone Fart App Pulls in Nearly $10,000 a Day”. Venture Beat. Dec. 23, 2008. http://venturebeat.com/2008/12/23/iphone-fart-app-pulls-in-early-10000-a-day/on Apr. 10, 2015.
5. “The Shake Weight Hits $40 Million in Sales”. CNBC. Aug. 20, 2010. http://www.cnbc.com/id/38788941 on Apr. 10, 2015.
6. “Evaluation of an extremely flatulent patient: case report and proposed diagnostic and therapeutic approach”. Levitt et. al. The American Journal of Gastroenterology. November 1998. 2276-81.

1. A system for detection of an airborne analyte via a chemiluminescent spray, comprising as solution expelled simultaneously via actuation of a spray bottle to form a chemiluminescent reaction in the atmosphere upon the presence of the airborne analyte.
